(19) United States
(12) Patent Application Publication
(10) Pub. No.: US 2021/0103991 A1
(43) Pub. Date: Apr. 8, 2021

(54) Method and System for Medical Malpractice Insurance Underwriting Using Value-Based Care Data

(71) Applicants: Camille Chicklis, (US); Acadia Professional, LLC, Morristown, NJ (US)

(72) Inventors: Brian Kern, Morristown, NJ (US); Camille Chicklis, Somerville, MA (US)

(73) Assignee: Acadia Professional, LLC, Morristown, NJ (US)

(21) Appl. No.: 16/595,864

(22) Filed: Oct. 8, 2019

(51) Int. Cl. G06Q 40/08; G06N 20/00; G06N 5/02

(52) U.S. Cl. CPC G06Q 40/08; G06N 5/02; G06N 20/00

(57) ABSTRACT

A method and system for automated computer-based medical malpractice insurance underwriting using value-based care data is disclosed. A machine-learning based predictive model is trained to predict a risk of a medical malpractice claim from a provider data set including value-based care data and social factor data. A provider data set including value-based care data and social factor data for a provider is retrieved. The provider data set is input into the trained machine-learning based predictive model. A risk score indicating a risk of a medical malpractice claim for the provider is predicted based on the input provider data set using the trained machine-learning based predictive model. A premium for medical malpractice insurance is determined for the provider based on the predicted risk score. The predictive modeling method can also be used to predict stop loss risk and determine a combined premium for medical malpractice and stop loss insurance.

### BACKGROUND OF THE INVENTION

The present invention relates to medical malpractice underwriting, and more particularly to automated computer-based medical malpractice insurance underwriting using value-based care data and a machine-learning based predictive model.

For decades, the medical malpractice insurance industry has underwritten professional liability insurance policies for physicians, allied healthcare providers and medical groups/systems (collectively referred to as “providers”) by using narrow criteria. Such criterion falls into two basic categories. The first category of criteria used for medical malpractice insurance underwriting is simply biographic information, most of which can be obtained through credentialing bodies. Such credentialing information includes a provider's specialty, which in addition to procedures and scope of practice (at times requiring further inquiry), is used to place that provider into the appropriate category and charge a corresponding “base premium.” The second category of criteria used for medical malpractice underwriting is a provider's “claim history,” i.e., whether a provider has been involved in a lawsuit(s) and the total cost of resolving the lawsuit(s). This cost is referred to herein as “total loss.”

Based on claim history, a healthcare provider will receive surcharges (debits) added to the base premium or discounts (credits) subtracted from the based premium. For a particular provider, the following formula is used to calculate a loss ratio:

Total Loss/(Premium×Year in Practice)=Loss Ratio.

For example, assume a physician pays $50,000 a year premium for ten years, and her total loss is $400,000. In this case, the loss ratio for the physician is calculated as $400,000/($50,000×10 years)=$400,000/$500,000=80% loss ratio. An 80% loss ratio will qualify a physician for a corresponding credit or debit. If the physician is part of a group, group credits can be applied as well.

The above framework for medical malpractice insurance underwriting is devoid of any predictive analytics. By extension, the medical malpractice insurance industry is built upon reactive analytics. Despite the ever-increasing availability of new healthcare datasets, the medical malpractice insurance industry remains committed to this conventional modeling framework. As mentioned above, the conventional modeling used for medical malpractice insurance underwriting uses credentialing and claim history data almost exclusively and incorporates little to no outside data. This can be seen in medical malpractice insurance companies' underwriting manuals, which are public documents. However, an improved underwriting process that is predictive rather than reactive can provide considerable benefits, and is therefore highly desirable.

### BRIEF SUMMARY OF THE INVENTION

The present invention provides a method and system for automated computer-based medical malpractice insurance underwriting using value-based care data. Embodiments of the present invention train a predictive model that learns correlations between value-based care data and medical malpractice lawsuits. The predictive model is applied to predict risk levels of being subject to medical malpractice litigation, and provider premiums for medical malpractice insurance are determined based on the predicted risk levels.

In an embodiment of the present invention, a computer-implemented method comprises: training a machine-learning based predictive model to predict a risk of a medical malpractice claim based on training cases with known outcomes and associated training provider data sets including value-based care data and social factor data; retrieving a provider data set including value-based care data and social data for a provider; inputting the provider data set into the trained machine-learning based predictive model; predicting, using the trained machine-learning based predictive model, a risk score indicating a risk of a medical malpractice claim for the provider based on the input provider data set; and determining a premium for medical malpractice insurance for the provider based on the risk score predicted using the trained machine-learning based predictive model.

In an embodiment, the value-based care data in the provider data set includes one or more of patient satisfaction scores, quality metrics, procedure outcome data, hospital readmission data, or utilization data.

In an embodiment, the social factor data in the provider data set includes one or more of social factor data associated with the provider or social factor data associated with patients of the provider.

In an embodiment, the social factor data associated with the provider includes one or more of credit score data, income data, spending data, data related to patient complaints, dated related to staff complaints, or data related to civil, criminal, or regulatory actions.

In an embodiment, the social factor data associated with the patients of the provider includes socio-economic data associated with the patients of the provider, including one or more of income, zip code, family circumstances data, or data regarding assets of the patients.

In an embodiment, training a machine-learning based predictive model to predict a risk of a medical malpractice claim based on training cases with known outcomes and associated training provider data sets including value-based care data and social factor data comprises: identifying positive training cases in which providers were subject to medical malpractice claims and negative training cases in which providers were not subject to medical malpractice claims; retrieving a training provider data set including value-based care data and social factor data for each of the positive training cases and for each of the negative training cases; processing and cleaning the provider data sets for the positive and negative training cases to perform imputation of missing values, reduce excessive dimensionality, and address data imbalance; and training the machine-learning based predictive model based on the training provider data sets and known outcomes of the positive training cases and negative training cases.

In an embodiment, the method further comprises: pre-processing the provider data set to perform imputation of missing values prior to inputting the provider data set into the trained machine-learning based predictive model.

In an embodiment, the machine-learning based predictive model is a deep neural network.

In an embodiment, the method further comprises: training a second machine-learning based predictive model to predict a risk of a stop loss claim based on training cases with known outcomes and associated training provider data sets including value-based care data and social factor data; inputting a second provider data set, including value-based care data and social data for the provider, to the trained second machine-learning base predictive model; and predicting, using the trained second machine-learning based predictive model, a second risk score indicating a risk of a stop loss insurance claim for the provider based on the input second provider data set; wherein determining a premium for medical malpractice insurance for the provider based on the risk score predicted using the trained machine-learning based predictive model comprises: determining a combined premium for medical malpractice insurance and stop loss insurance for the provider based on the risk score predicted using the trained machine-learning based predictive model and the second risk score predicted using the trained second machine-learning based predictive model.

In an embodiment of the present invention, a system comprises a processor and a memory storing computer program instructions. The computer program instructions, when executed by the processor cause the processor to perform operations comprising: training a machine-learning based predictive model to predict a risk of a medical malpractice claim based on training cases with known outcomes and associated training provider data sets including value-based care data and social factor data; retrieving a provider data set including value-based care data and social data for a provider; inputting the provider data set into the trained machine-learning based predictive model; predicting, using the trained machine-learning based predictive model, a risk score indicating a risk of a medical malpractice claim for the provider based on the input provider data set; and determining a premium for medical malpractice insurance for the provider based on the risk score predicted using the trained machine-learning based predictive model.

In an embodiment of the present invention, a non-transitory computer-readable medium stores computer program instructions, which when executed by a processor cause the processor to perform operations comprising: training a machine-learning based predictive model to predict a risk of a medical malpractice claim based on training cases with known outcomes and associated training provider data sets including value-based care data and social factor data; retrieving a provider data set including value-based care data and social data for a provider; inputting the provider data set into the trained machine-learning based predictive model; predicting, using the trained machine-learning based predictive model, a risk score indicating a risk of a medical malpractice claim for the provider based on the input provider data set; and determining a premium for medical malpractice insurance for the provider based on the risk score predicted using the trained machine-learning based predictive model.

These and other advantages of the invention will be apparent to those of ordinary skill in the art by reference to the following detailed description and the accompanying drawings.

### BRIEF DESCRIPTION OF THE DRAWINGS

FIG. 1 illustrates a system for automated computer-based medical malpractice insurance underwriting according to an embodiment of the present invention;

FIG. 2 is a high-level block diagram of a computer capable of implementing embodiments of the present invention;

FIG. 3 illustrates a high-level diagram of a predictive model for predicting the risk of medical malpractice litigation according to an embodiment of the present invention;

FIG. 4 illustrates a method for training a predictive model for automated computer-based medical malpractice underwriting according to an embodiment of the present invention;

FIG. 5 illustrates a method of computer-based automated medical malpractice insurance underwriting according to an embodiment of the present invention; and

FIG. 6 illustrates a method for computer-based automated combined medical malpractice insurance and stop loss insurance underwriting according to an embodiment of the present invention.

### DETAILED DESCRIPTION

The present invention relates to a method and system for automated computer-based medical malpractice insurance underwriting using value-based care data.

As described above, the conventional framework medical malpractice insurance underwriting utilizes credentialing data and claim history data almost exclusively. However, the present inventors have concluded that medical malpractice lawsuits are not best predicted merely by whether the provider has been involved in medical malpractice lawsuits in the past. The very notion renders it impossible to predict the occurrence of a first medical malpractice lawsuit for a provider. The present inventors contend that a claim should not serve as a predictor of more forthcoming claims, but rather as the product of myriad factors. Embodiments of the present invention utilize machine learning to “learn” correlations between such factors and medical malpractice claims in order to train a predictive model that can predict the likelihood/risk of future medical malpractice claims for a provider.

A leading national medical malpractice insurance company aggregates and interprets claims data with the mission of addressing the “cause” of each claim. In addition, research has been conducted on the ages of providers when they are the subject of a professional liability (medical malpractice) claim. However, companies have stopped short of identifying a direct link between performance measures, many of which can be ascertained via “value-based care” programs, and medical malpractice claims. Part of the reason is that obtaining such information and using it to predict future claims is innovative and complicated.

Embodiments of the present invention obtain such value-base care data and synthesize it into a predictive model. The present inventors have determined that the performance measures in the value-based care data provide key factors that can help predict when providers are more at risk of being the subject of medical malpractice litigation. While there is no perfect correlation between any particular factor and risk of medical malpractice litigation, embodiments of the present invention utilize machine learning to learn a predictive model that combines the predictive power of various value-based care data/performance measures to identify those providers most vulnerable to a medical malpractice claim.

Embodiments of the present invention provide an automated computer-based method for medical malpractice underwriting in which a supervised machine-learning model is utilized to train a predictive model to predict a risk of medical malpractice lawsuits from value-care based data. The trained predictive model is then used to predict the risk of medical malpractice lawsuits for providers and provider premiums are determined based on the predicted risk. The method described herein provides numerous benefits/advantages as compared to the conventional medical malpractice insurance underwriting framework.

One benefit is that instead of reacting to lawsuits filed against a particular provider, the predictive modeling method described herein will help insurance companies and providers identify risks before claims are filed, thereby creating a proactive environment and allowing companies to deploy resources in a far more valuable manner. The use of value-based care data to predict latent professional negligence and potential resulting lawsuits allows insurance companies to identify providers at risk of future medical malpractice lawsuits, even if they have not previously been subject to a medical malpractice lawsuit.

Another benefit of the method described herein is the prevention or burnout. “Physician burnout” is a term used to describe the consequences of placing unending responsibilities on providers. For example, government mandates, payor policies and procedures, and hospital requirements, are a few of the biggest. Reimbursements are also falling. So physicians are forced to see more patients to maintain their income level, while dealing with these burdensome responsibilities. Lawsuits, or even the risk of getting sued, can weigh heavily on providers. Adding “risk management” to this list of responsibilities can be draining. The use of the method described herein will eliminate or consolidate additional burdens on providers. The reason is because the same activities necessary to improve value-based care performance will be identical to those needed to address exposure to professional negligence and resulting legal actions. In addition, the training process used to train the predictive model can also identify which value-based care factors most strongly correlate to risk of medical malpractice lawsuit, thus providing important feedback to providers on where to focus their attention.

Another benefit is that the method described herein will create numerous efficiencies. Medical malpractice insurance companies collect billions of dollars in annual premiums to insure against professional liability claims. Claim expenses account for roughly 75% of all premiums collected. The rest is spent on business expenses, which include broad, reactive risk management programs. The predictive modeling method described herein will allow money spent to be more targeted to prevent claims and/or complications before they occur. This will result in a more efficient medical malpractice insurance industry, and lower premiums for providers. Accordingly, the predictive modeling process described herein will contribute to lowering the cost of healthcare.

Another advantage of the method described herein is preventing complications and poor patient outcomes. Ultimately, a medical malpractice lawsuit is the byproduct of a complication and some element of patient suffering. With almost no exception, providers set out to treat, help, and heal patients. The last thing they want is for their patients to have any adverse results. Unfortunately, it is difficult to see such poor patient outcomes coming, and once they occur they can no longer be prevented. Increasing premiums on a physician whose patient(s) was the subject of the adverse event is punitive. The multi-billion dollar medical malpractice insurance industry can and should take more responsibility for reducing and preventing adverse events, rather than using them as justification to collect larger premiums. Waiting for adverse events to increase premiums is a punitive approach. The predictive modeling method described herein provides a prediction of risk/likelihood of medical malpractice claims for providers, which allows providers to be alerted to their risk prior to a medical malpractice claim. According, the method described herein helps transition the industry from punishing providers (most of whom have spent their lives trying to help patients) to partnering with them to prevent adverse events from occurring. Indeed, the method described herein will allow the medical malpractice insurance industry to better serve its clients and fulfill what should be its mission. The predictive modeling method will usher in more targeted and successful investments to prevent poor patient outcomes, and therefore lawsuits.

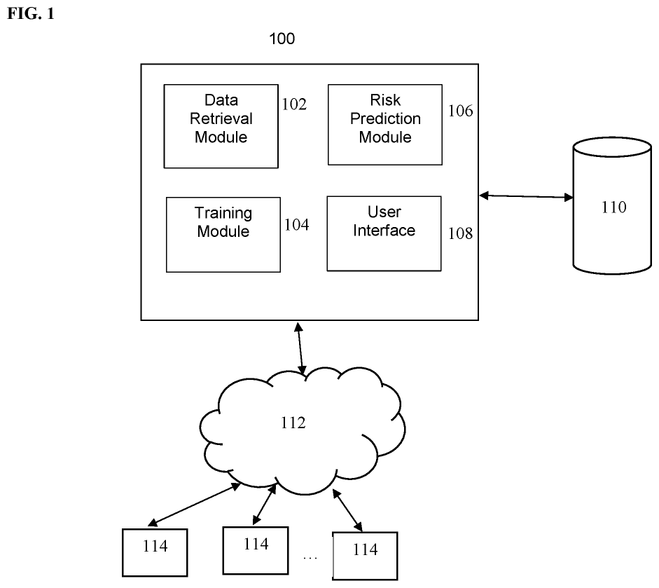

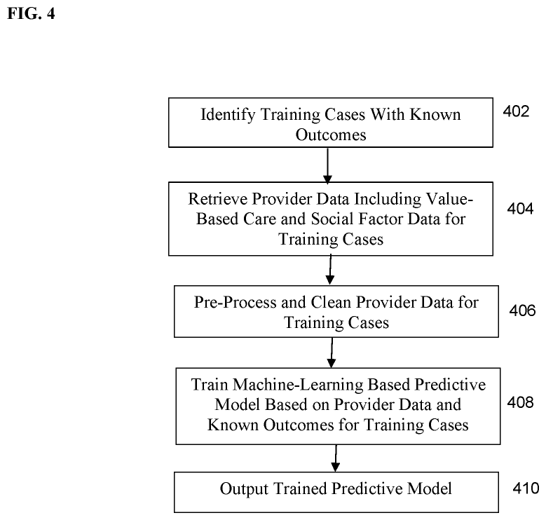

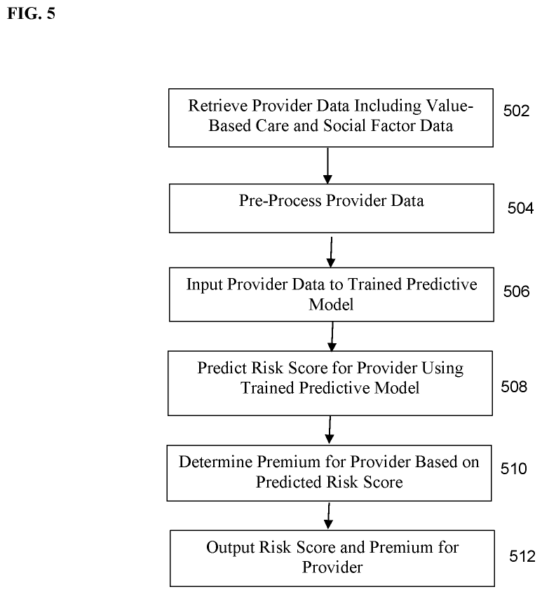

FIG. 1 illustrates a system for automated computer-based medical malpractice insurance underwriting according to an embodiment of the present invention. As shown in FIG. 1, the system includes a medical malpractice underwriting platform 100 and a database 110. The medical malpractice underwriting platform 100 includes a data retrieval module 102, training module 104, risk prediction module 106, and user interface 108. The medical malpractice underwriting platform 100 is implemented on a computer system including one or multiple computer devices. The operation of the medical malpractice underwriting platform 100, including the operation of the data retrieval module 102, training module 104, risk prediction module 106, and user interface 108, is defined by computer program instructions executed by one or more processors of the medical malpractice underwriting platform 100. These computer program instructions define a set of rules for automated computer-based medical malpractice underwriting that are different from mere computer implementation of manual medical malpractice underwriting. As will become apparent, the functions and operations of the medical malpractice underwriting platform 100 and the methods described below in FIGS. 4 and 5 are sufficiently complex as to require implementation on a computer system, and cannot be performed in the human mind using mental steps.

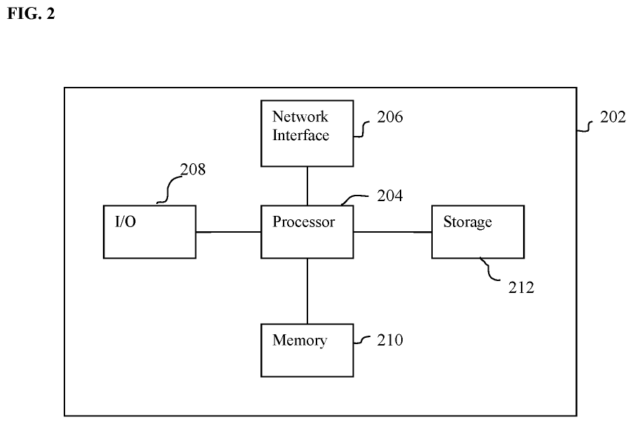

The medical malpractice underwriting platform 100 of FIG. 1, the method for training a predictive model for predicting medical malpractice litigation risk described in FIG. 4, and the method of automated computer-based medical malpractice underwriting described in FIG. 5 may be implemented on a computer or multiple computers using computer processors, memory units, storage devices, computer software, and other components. A high-level block diagram of such a computer is illustrated in FIG. 2. Computer 202 contains at least one processor 204, which controls the overall operation of the computer 202 by executing computer program instructions which define such operation. It is to be understood that the computer 202 may include multiple processors 204, including any type of processor (e.g., central processing unit (CPU), graphical processing units (GPUs), multi-core processors, etc.). The computer program instructions may be stored in a storage device 212 (e.g., magnetic disk) and loaded into memory 210 when execution of the computer program instructions is desired. Thus, the operations of the data retrieval module 102, training module 104, risk prediction module 106, and user interface 108, and the steps of the methods of FIGS. 4 and 5 may be defined by the computer program instructions stored in the memory 210 and/or storage 212 and controlled by the processor 204 executing the computer program instructions. The computer 202 also includes one or more network interfaces 206 for communicating with other devices via a network. The computer 202 also includes other input/output devices 208 that enable user interaction with the computer 202 (e.g., display, keyboard, mouse, speakers, buttons, etc.). One skilled in the art will recognize that an implementation of an actual computer could contain other components as well, and that FIG. 2 is a high-level representation of some of the components of such a computer for illustrative purposes.

The medical malpractice underwriting platform 100 may be implemented on a computing system that is local to the end users(s) (e.g., medical malpractice insurance professional/company) or on a computing system that is remote from the end user(s). In one embodiment, the medical malpractice underwriting platform 100 may be implemented on computing device that is a server which performs automated medical malpractice underwriting in response to requests received from one or more client devices. In another embodiment, the medical malpractice underwriting platform 100 may be implemented on a cloud computing system and performs automated medical malpractice underwriting as a cloud-based service. In this case, the cloud computing system may include multiple networked computing devices, and the operations of the medical malpractice underwriting platform 100 (and the method steps of FIGS. 4 and 5) may be distributed over various ones of the networked computer devices of the cloud computing system.

Returning to FIG. 1, the data retrieval module 102 of the medical malpractice underwriting platform 100 communicates with the database 110 to control data relating to providers seeking medical malpractice insurance to be stored in the database 110 and to retrieve such provider data from the database 110. The data retrieval module 102 constructs a provider data set for each provider seeking medical malpractice insurance by retrieving data relating to that provider, including value-based care data and social factor data, from one or more data sources. The data retrieval module 102 stores the provider data set for each provider in the database 110.

According to an advantageous embodiment, the provider data set for each provider includes value-based care data and social factor data. The term “value-based care” refers to a new reimbursement paradigm for the United States healthcare system. The goal is to transition away from a “fee-for-service” system, under which a provider only gets reimbursed for performing a specific service or procedure. “Value-based care” is a term that describes a system in which providers get compensation based on outcomes, quality, patient satisfaction, and cost. “Value-based care data” is the data that goes into determining the compensation in a value-based care system. In particular, the value-based care data can include one or more of the following: patient satisfaction scores, quality metrics, outcome data, and/or utilization data. Patient satisfaction scores are generally obtained by surveys conducted by payors or other third party vendors to obtain feedback on a variety of personal and clinical questions related to the patient experience and clinical outcome. Quality metrics refer to both self-reported and outcome-based measures that have been determined to the lower cost and improve the quality of care. Outcome data can be the end result of a specific procedure (i.e., 100% range of motion within 6 months) or can be more broadly related to chronic disease management (i.e. insulin or hemoglobin levels). Utilization can include everything from the lengths of stays at rehabs or skilled nursing facilities, hospice, etc., to home health services provided, to drugs prescribed or tests ordered, as well as other possible value-based care measures recorded as part of a value-based care system. Value-based care data can be used to improve outcomes and thereby reduce risk. Stop loss insurance underwriting models often rely on limited value-based care data to price coverage. Embodiments of the present invention not only utilize this data in our medical malpractice predictive model, but create unprecedented efficiencies by integrating financial and professional liability risk.

The social factor data included in the provider data set for each provider can include social factor data related to the patients of the provider (“patient social factor data”) and/or social factor data related to the provider (“provider social factor data”). The term “social factor” is taken from a concept known as social determinants of health. Social determinants of health are specific data points related to a patient's environment. The patient social factor data can include such social determinants of health. Examples include salary, education, whether a patient has a car (can they drive to medical appointments), whether a patient lives with a family member (can such a person assist in implementing a care plan), and whether a patient must walk up stairs to get to an apartment or bed (possibly contributing to a complication following an orthopedic procedure). Socio-economic factors have been the most telling predictors of patient that will have the most complications, and thus, should receive the most attention and resources. In addition to the data itself, whether or not and how much a provider pays attention to this patient social factor data may also be a predictor of the provider's risk of medical malpractice litigation. Accordingly, the social factor data may include data indicating whether or how much patient social factor data is recorded by the provider. In addition to this patient social factor data, provider social factor data includes social and/or economic factors related to the provider. For example, provider social factor data can include change in credit score, change in income, change in personal spending habits, civil, criminal or regulatory actions, patient complaints, and/or complaints from staff (medical staff or administration).

In an advantageous embodiment, the data retrieval module 102 communicates with one or more external data sources 114 via a data network 112 in order to retrieve the provider data, including the value-base care data and social factor data, from the external data sources 114. The external sources 114 from which the data retrieval module 112 can retrieve the value-based care data and the social factor data can include the center for Medicare and Medicaid Services (CMS), private payors, employers, credit agencies, credentialing bodies (e.g., Council for Affordable Quality Healthcare (CAQH)), and/or background checks. Several public CMS datasets provide value-based care information for physicians treating Medicare and Medicaid patients, including their quality, patient satisfaction, cost, and utilization rates. CMS Physician Compare is a publicly-available dataset which uses data from Medicare claims, clinical data registries, patient surveys, and provider surveys to provide quality scoring information for physicians. The quality measures on CMS Physician Compare include both process-based quality measures, which evaluate the use of clinically-appropriate processes, and outcome-based measures, which evaluate specific outcomes such as complications. Topically, these measures cover the management of chronic conditions, use of preventative care, healthcare-related infections, medication management, overutilization of services, and patient satisfaction, and some metrics are risk-adjusted to account for differences in patient case-mix. This data is available both for individual providers and for group practices, and both can be incorporated into the value-based care factor data. CMS also maintains public databases for cost, quality, and settlements for institutions; for example, Medicare Hospital Compare provides similar information as Physician Compare, and the Medicare Provider Cost Report Public Use Files provide Medicare settlement amounts. Public reviews of physicians can be part of the value-based care factors. For example, Healthgrades provides scoring on metrics such as trustworthiness, explaining conditions well, and answering questions; both scoring information and textual reviews such as sentiment analysis can be incorporated into the algorithm. Physician prescribing patterns, such as those found in the ProPublica Prescriber Checkup, which leverages Medicare Part D prescription data, can also be incorporated. In addition, data from value-based care programs, such as bundles, pay-for-performance, shard savings, quality, accountable care organizations, and capitation programs, from both public and private payors, can inform the model. This data can include publicly-available reports and statistics as well as detailed claim/line or provider-level results and benchmarks that are shared with practices and individuals, both on an ongoing basis and from historical results. Results and trends from these programs can provide highly specific data on provider performance and intention to shift to value-based care. For example, data from Medicare's Bundled Payment for Care Improvement Advanced (BPCI-A) program can include raw claim/lines billed by providers; peer-group comparisons; expected spending trends; and reconciliation information which compares actual performance to expected performance. Healthcare information exchanges (HIEs) can be incorporated as a source of data for the predictive model, including those managed by state agencies, private and/or proprietary HIEs, and others. Data from HIEs that can be used in the predictive model includes quality metrics, performance data, cost and utilization data, and electronic health record (HER) usage, among others. This data can come from multiple payors and providers.

Social factor data for providers can be included from third-party personal data sources. For example, risk mitigation data sources can provide information about background checks, while credit reporting services can provide credit scores and changes in scores over time. State-level credentialing, board actions, and disciplinary action can also be incorporated. In addition, the National Practitioner Data Bank (NPDB) Public Use Data File contains information at the physician-level from all medical malpractice, adverse licensure, Drug Enforcement Administration, and professional society membership for all reports received by the NPDB, as well as CMS actions taken. For some external data sources 114, the data retrieval module 102 of the medical malpractice underwriting platform 100 may access a database associated with the external data source 114 to retrieve data from that external data source. This may require an insurance company using the medical malpractice underwriting platform 100 to have an agreement with external data sources 114 such as the CMS, partner with medical practices, and/or engage private payors or employers. Data may be accessed through API pulls or other data feeds.

The data retrieval module 102 also retrieves provider data sets for providers associated with training cases having known outcomes (e.g., known medical malpractice claims or no claims) to be used for training the predictive model, and stores such training data sets in the database 110.

The database 110 stores provider data sets (including value-based care data and social factor data) for providers seeking medical malpractice insurance. The database 110 also stores training provider data sets associated with training cases with known outcomes. The database 110 can be implemented as a relational database and can be maintained and controlled by the medical malpractice underwriting platform 100 using a database management system (DBMS).

The training module 104 trains a machine-learning based predictive model to predict a risk level/likelihood of a medical malpractice claim for a provider based on the provider data set including the value-based care data and social factor data. Positive training cases in which medical malpractice claims have been brought against a provider and the amount of those claims and negative training cases in which medical malpractice claims have not been brought against a provider are identified. The data retrieval module 102 retrieves the training provider data sets associated with the positive and negative training cases and inputs the training provider data sets to the training module 104. The training module 102 trains the predictive model to learn a mapping from the provider data sets to the known outcomes (medical malpractice claim or no medical malpractice claim) associated with the training provider datasets. As an alternative or in addition to just the presence or absence of a medical malpractice claims, the known outcomes used to train the predictive model can include the total loss resulting from medical malpractice claims for a provider ($0 for providers with no claims). This can be used to train the predictive model to classify providers into different risk levels, such as high, medium, and low risk, where a higher risk level translates into a higher premium. The trained predictive model is stored (e.g., in storage or memory of the computer system) to be used by the risk prediction module 106.

In an advantageous embodiment, the training module 104 first cleans and processes the data. This data cleaning addresses aspects of the data that would bias or limit the usage of the results. For example, it can be expected that some physicians for whom we have malpractice outcome information will not have data in all of our value-based care and social factors datasets, so the model incorporates imputation of missing values. The model also uses techniques to reduce excessive dimensionality such as principal component analysis, which leverages eigenvectors to identify the features that capture the most variability in the data. Finally, because the outcome of a malpractice claim is a rare event, the module incorporates sampling-based and/or cost-sensitive methods to address the data imbalance, such as random over-sampling or synthetic sampling with data generation.

In an advantageous embodiment, the training module 104 uses supervised deep learning to train the predictive model based on the training data sets. In this embodiment, the predictive model can be implemented as a deep neural network (DNN), such as a convolutional neural network (CNN). A DNN is a neural network with multiple hidden layers of nodes/neurons between the input layer and output layer. The input layer of the medical malpractice predictive model DNN inputs the provider data set (including the value-based care and social factor data) and the output layer outputs a risk score that indicates a likelihood of a medical malpractice claim for a provider. The medical malpractice predictive model DNN may also classify the provider into one of multiple classes (e.g., high risk, low risk, etc.) based on the risk score. The medical malpractice predictive model DNN includes multiple hidden layers between the input layer and output layer that extract higher level features from the raw input. Each hidden layer includes a plurality of nodes/neurons with weights that are learned during the training. During each epoch, the error from the output is identified and back-propagated into the model. Stochastic gradient descent uses the error to adjust the weight of each hidden layer of the DNN by minimizing a loss function between the known outcomes and the risks predicted by the DNN over the set of training cases. In addition, the model can use longitudinal data to identify inflection points at which the provider's behavior, performance, or social factors change and how those changes affect their likelihood of a claim over time. Longitudinal data can be incorporated with appropriate choice and design of neural network models and processing. For example, Long Short-Term Memory (LSTM) networks have a feedback connection that make them ideal models for time series data. A LSTM recurrent neural network can incorporate functions that account for the decreasing relevance of historical provider data over time while still incorporating the impact of past events. For other models, the data preprocessing can account for longitudinal data by aggregating a set of feature vectors for each provider in time.

In other embodiments, other possible supervised machine-learning algorithms can be used to train the predictive model. The machine-learning model can be implemented using a classification algorithm to predict risk levels. Given the expected size of the data, algorithms such as a linear support vector classifier, a stochastic gradient descent classifier, and/or a kernel approximation model can be used. For example, support vector machines identify categories of risk through finding the optimal hyperplane that delineates the categories. The model can be tuned through various hyperparameters, such as the kernel and regularization parameters.

The risk prediction module 106 uses the trained predictive model to predict a risk score for a provider based on the provider data set (including the value-based care data and the social factor data) associated with that provider. The provider data for a provider is retrieved by the data retrieval module 102 and input to the risk prediction module 106. The risk prediction module 106 first pre-processes the provider data. For example, since it can be expected that for some providers not all of the value-based care and social factors data will be available, the pre-processing can include imputation of missing values. The risk prediction module 106 then inputs the provider data set to the trained predictive model that was trained by the training module 104. The risk prediction module 106 applies the trained predictive model to process the input provider data set and compute a risk score for the provider based on the input provider data set. The trained predictive model can also classify the provider input one of multiple classes (e.g., high risk, low risk, etc.) based on the risk score computed for the provider. The risk prediction module 106 then determines a premium based on the risk score and/or the classification of the provider.

The user interface 108 is a graphical user interface that provides the results from the risk prediction module 106. For example, the user interface 108 can display the risk score predicted by the predictive model for a provider and the premium determined for the provider. The user interface may also display a classification (e.g., high risk, low risk, etc.) determined by the predictive model for the provider. The medical malpractice underwriting platform 100 may also display a warning regarding the risk for the provider and/or advice for how the provider can deploy risk management resources to address the issues causing the risk of medical malpractice. This can help companies deploy risk management resources to address emerging issues that lead to lawsuits rather than spending these resources on reactive measures and defending legal actions that could have been avoided. The user interface 108 may be displayed on a display of the medical malpractice underwriting platform 100. Alternatively, in the case in which the medical malpractice underwriting platform 100 is implemented on a server or cloud computing system, the user interface 108 may be displayed on a display of an end user (client) device which communicates with the medical malpractice underwriting platform 100 via the data network 112.

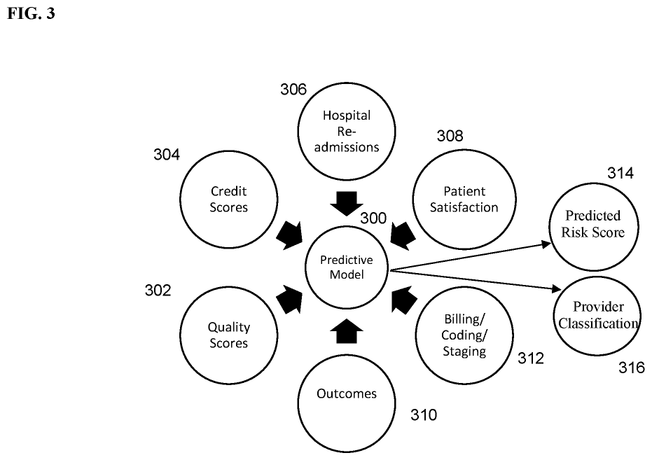

FIG. 3 illustrates a high-level diagram of a predictive model for predicting the risk of medical malpractice litigation according to an embodiment of the present invention. As shown in FIG. 3, the predictive model 300 inputs value care-based data and social factor data associated with providers and outputs predicted risk scores 314 for the providers. In particular, the predictive model 300 of FIG. 3 inputs value care-based data of quality scores 302, hospital readmissions 306, patient satisfaction scores 310, outcome data 310, and billing/coding/staging data 312. The predictive model 330 of FIG. 3 also inputs social factor data of provider credit scores 304. The predictive model processes the input data sets for the providers including the quality scores 302, credit scores 304, hospital readmissions 306, patient satisfaction scores 310, outcome data 310, and billing/coding/staging data 312, and generates predicted risk scores 314 for the providers. The predicted risk scores 314 computed by the predictive model 300 are prediction as to the risk or likelihood that the providers will be subject to a medical malpractice claim. The predictive model 300 may also classify the providers into various classes (e.g., high risk, low risk, etc.) and output the provider classification 316 for each provider. The predictive model 300 is trained based on provider data associated with known outcomes and may be implemented using a DNN.

Regarding the billing/coding/staging data 312, documentation has longed been considered essential to prudent risk management. Having a comprehensive patient history and workup is necessary to provide appropriate treatment. It is also essential when analyzing patient outcomes and complications. For example, if a patient with cancer is treated by an oncology group, and the group does not properly record all of the patient's co-morbidities, that patient might not receive the proper treatment, and complications could ensue. Good documentation can prevent complications. It will also prevent the data from being inaccurately used to identify high risk patients. Consider that if a group routinely fails to include diabetes in a workup, diabetics and non-diabetics alike will be misrepresented in the data. The same would be true for smokers and/or patients with other chronic conditions. In the oncology context, “staging” a patient is a careful process to determine what stage cancer a patient has. Accordingly, whether or not a provider has well-documented billing, coding, and (when applicable) staging data, as well as the extent of such data, can be predictive as to the risk of medical malpractice litigation for that provider.

The automated computer-based medical malpractice insurance underwriting using the predictive model described herein is performed in two stages: a training stage, in which the predictive model is trained; and a prediction stage in which the trained predictive model is used to predict risk and determine premiums for one or more providers seeking medical malpractice insurance.

FIG. 4 illustrates a method for training a predictive model for automated computer-based medical malpractice underwriting according to an embodiment of the present invention. At step 402, training cases with known outcomes are identified. In particular, positive training cases in which providers have been subject to a medical malpractice claim are identified, and negative training cases in which providers have not been subject to a medical malpractice claim are identified.

At step 404, provider data, including value-based care data and social factor data, is retrieved for each of the training cases. For each positive training case, the value-based care data and social factor data (patient and/or provider social factor data) for a specified amount of time prior to the medical malpractice claim can be retrieved. For each negative training case, value-based care data and social factor data can be retrieved from the same time period.

At step 406, the provider data for the training cases is processed to clean the data and prepare the data for training the predictive model. The data cleaning addresses aspects of the data that would bias or limit the usage of the results. For example, it can be expected that some physicians for whom we have malpractice outcome information will not have data in all of our value-based care and social factors datasets, so the model incorporates imputation of missing values. The data processing also applies techniques to reduce excessive dimensionality such as principal component analysis, which leverages eigenvectors to identify the features that capture the most variability in the data. Finally, because the outcome of a malpractice claim is a rare event, sampling-based and/or cost-sensitive methods are applied to address the data imbalance, such as random over-sampling or synthetic sampling with data generation.

At step 408, a machine-learning based predictive model is trained based on the provider data and known outcomes for the training cases. The predictive model is trained to learn a mapping from the provider data to the known outcomes (medical malpractice claim or no medical malpractice claim) for the positive and negative training cases. In an advantageous embodiment, the predictive model can be implemented as a DNN, such as a convolutional neural network (CNN). The input layer of the DNN inputs the provider data set (including the value-based care and social factor data) and the output layer outputs a risk score that indicates a likelihood of a medical malpractice claim for a provider. The DNN may also classify the provider into one of multiple classes (e.g., high risk, low risk, etc.) based on the risk score. The DNN includes multiple hidden layers between the input layer and output layer, each including a plurality of nodes/neurons with weights that are learned during the training. Gradient descent and back-propagation training algorithms can be used to learn weights for the hidden layers of the DNN that minimize a loss function between the known outcomes and the risks predicted by the DNN over the set of training cases. In other embodiments, other possible machine-learning algorithms can be used to train the predictive model.

At step 410, the trained predictive model is output. The trained predictive model is stored in storage or memory of a computing system to be used to predict risk scores for providers based on newly input provider data sets. In addition, the feature importances and/or feature visualizations of the trained predictive model can provide insight into which factors in the provider data set cause higher or lower risk scores to be predicted. This information is important for insurance companies to deploy risk management resources to lower the risk of medical malpractice litigation for providers.

FIG. 5 illustrates a method of computer-based automated medical malpractice insurance underwriting according to an embodiment of the present invention. At step 502, a provider data set including value-based care data and social factor data is retrieved. The provider data set can include value-based care data and social factor data associated with the provider from a specified time frame. This provider data can be retrieved from one or more data sources, such as the CMS, private payors, employers, credit rating agencies, credentialing bodies, and/or background checks in order to construct the provider data set for a provider. If the provider data set has already been constructed and stored, this provider data set can be retrieved from the database in which it is stored.

At step 504, the provider data set is pre-processed to clean the provider data and prepare the provider data set for processing by the trained predictive model. For example, since it can be expected that for some providers not all of the value-based care and social factors data will be available, the pre-processing can include imputation of missing values in the provider data set.

At step 506, the provider data set is input to the trained predictive model. The predictive model can be trained as described above in the method of FIG. 4. In an advantageous embodiment, the predictive model can be implemented as a DNN, such as a convolutional neural network (CNN). In this case, the provider data set is input to the input layer of the trained DNN.

At step 508, a risk score for the provider is predicted using the trained predictive model. The trained predictive model processes the input provider data set and computes a predicted risk score for the provider from the input provider data set. The predicted risk score is a prediction of the likelihood of a medical malpractice claim for the provider. The trained predictive model can also classify the provider into one of multiple classes (e.g., high risk, low risk, etc.).

At step 510, a premium is determined based at least in part on the predicted risk score. In an exemplary implementation, the premium may be determined based on a combination of the predicted risk score and the generally accepted medical malpractice insurance underwriting criteria. The premium for medical malpractice insurance for the provider can be determined from the predicted risk score, from the physician “classification” (e.g., high risk, low risk etc.), or by combining the physician “classification” and the predicted risk score using a predetermined formula.

At step 512, the predicted risk score and the premium determined for the provider are output. The predicted risk score and the premium for the provider can be displayed on a display of the medical malpractice underwriting platform 100 and/or displayed on a display of an end user device or client device in communication with the medical malpractice underwriting platform 100. For example, such an end user or client device may be a device associated with an insurance company and/or a device associated with the provider. The predicted risk score and the premium may be automatically transmitted to the provider. For example, the predicted risk score and premium may be automatically transmitted in an e-mail message or any other electronic transmission format. In a possible implementation, in response to a risk score and/or classification that indicates the provider is at high risk for a medical malpractice claim, an alert may be automatically generated and sent to the provider and/or the insurance company. The alert may include specific areas for the provider determined by the predictive model that are causing the predicted risk score to be high. This allows the provider and/or the insurance company to proactively deploy resources to address emerging issues that put the provider at risk for a medical malpractice claim.

According to a possible embodiment of the present invention, the methods described above for automated computer-based medical malpractice underwriting may be modified to combine medical malpractice insurance with other professional/financial risk products. For example, in an advantageous implementation, the automated computer-based combined underwriting for medical malpractice insurance and stop loss insurance can be performed.

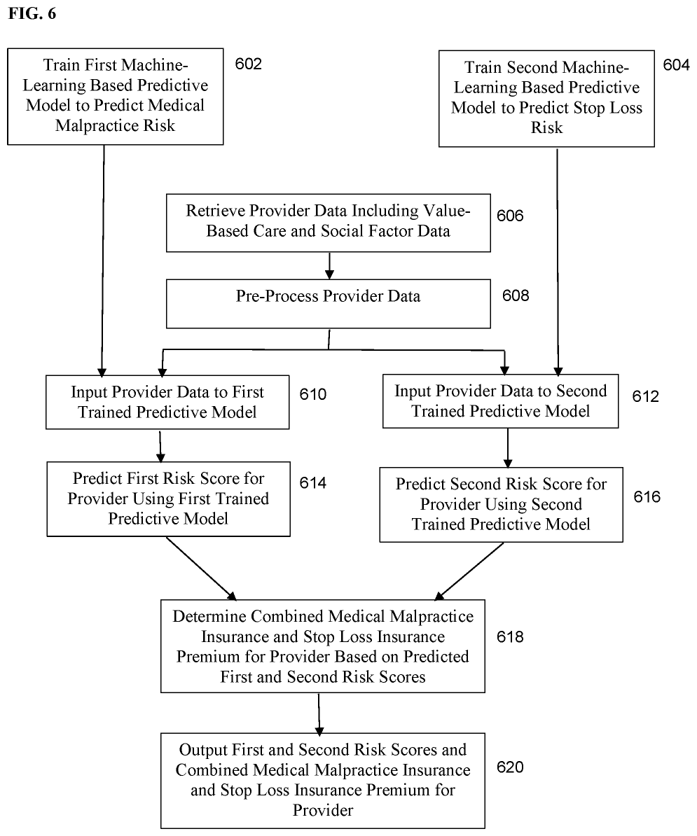

FIG. 6 illustrates a method for computer-based automated combined medical malpractice insurance and stop loss insurance underwriting according to an embodiment of the present invention. Steps 602 and 604 of FIG. 6 are performed in a training phase to train first and second predictive models, prior to steps 606-620, which are performed for each provider to predict risk of medical malpractice and stop loss and determined a combined premium for medical malpractice and stop loss insurance for each provider.

At step 602, a first machine-learning based predictive model is trained to predict medical malpractice risk for providers based on provider data including value-based care data and social factor data. The first machine-learning based predictive model is trained based on provider data in training cases with known outcomes, as described above in the method of FIG. 4.

At step 604, a second machine-learning based predictive model is trained to predict stop loss risk based on provider data including value-based care data and social factor data. The second predictive model can be trained based on provider data in training cases with known outcomes for stop loss claims using a method similar to the method of FIG. 4 used to train the first predictive model. In particular, training cases with known outcomes of stop loss claims (positive) no stop loss claims (negative) are identified. Provider data, including value-based care data and social factor data, is retrieved for each of the training cases. The provider data may include the same set value-based care and social factor as used for training the first predictive model or may include a different set of value-based care and social factor as used for training the first predictive model. The provider data for the training cases is processed to clean the data and prepare the data for training the predictive model, as described above in step 406 of FIG. 4. The second machine-learning based predictive model is then trained based on the provider data and known outcomes for the training cases. The second predictive model is trained to learn a mapping from the provider data to the known outcomes (stop loss claim or no stop loss claim) for the positive and negative training cases. In an advantageous embodiment, the second predictive model can be implemented as a DNN that outputs a risk score that indicates a likelihood of a stop loss claim for a provider. The second predictive model may also classify the provider into one of multiple classes (e.g., high risk, low risk, etc.) based on the risk score. In other embodiments, other possible machine-learning algorithms can be used to train the predictive model.

At step 606, provider data, including value-based care data and social factor data, is retrieved for a provider. The provider data set can include value-based care data and social factor data associated with the provider from a specified time frame. This provider data can be retrieved from one or more data sources, such as the CMS, private payors, employers, credit rating agencies, credentialing bodies, and/or background checks in order to construct the provider data set for a provider. If the provider data set has already been constructed and stored, this provider data set can be retrieved from the database in which it is stored.

At step 608, the provider data set is pre-processed to clean the provider data and prepare the provider data set for processing by the first and second trained predictive models. For example, since it can be expected that for some providers not all of the value-based care and social factors data will be available, the pre-processing can include imputation of missing values in the provider data set needed for each of the predictive models.

At step 610, the provider data is input to the first trained predictive model. At step 612, the provider data is input to the second trained predictive model. In one possible implementation, a first provider data set is input to the first predictive model and a second provider data set, which includes different value-based care and/or social factor data, is input to the second predictive model. In another possible implementation, the provider data input to the first and second predictive models includes the same value-based care and social factor data for the provider.

At step 614, a first risk score for the provider is predicted using the first trained predictive model. The first trained predictive model processes the input provider data and computes a predicted first risk score for the provider from the input provider data. The first predicted risk score is a prediction of the likelihood of a medical malpractice claim for the provider. The first trained predictive model can also classify the provider into one of multiple classes (e.g., high risk, low risk, etc.) relating to medical malpractice.

At step 616, a second risk score for the provider is predicted using the second trained predictive model. The second trained predictive model processes the input provider data and computes a predicted second risk score for the provider from the input provider data. The second predicted risk score is a prediction of the likelihood of a stop loss claim for the provider. The second trained predictive model can also classify the provider into one of multiple classes (e.g., high risk, low risk, etc.) relating to stop loss.

At step 620, a combined medical malpractice insurance and stop loss insurance premium is determined based at least in part on the predicted first and second risk scores. In an exemplary implementation, the premium may be determined based on a combination of the predicted first and second risk scores, the generally accepted medical malpractice insurance underwriting criteria, and the generally accepted stop loss insurance underwriting criteria. The predicted first and second risk scores may be combined to determine a combined risk score, which is used to determine the premium or may be used individually. The combined medical malpractice insurance and stop loss insurance premium for the provider can be determined from the predicted first and second risk scores, from the physician classifications (e.g., high risk, low risk etc.) for medical malpractice and stop loss, or by combining the physician classifications and the predicted first and second risk scores using a predetermined formula.

At step 620, the predicted first and second risk scores and the combined medical malpractice insurance and stop loss insurance premium determined for the provider are output. The predicted first and second risk scores and the combined premium for the provider can be displayed on a display of the medical malpractice underwriting platform 100 and/or displayed on a display of an end user device or client device in communication with the medical malpractice underwriting platform 100. For example, such an end user or client device may be a device associated with an insurance company and/or a device associated with the provider. The predicted first and second risk scores and the combined premium may be automatically transmitted to the provider. For example, the predicted first and second risk scores and the combined premium may be automatically transmitted in an e-mail message or any other electronic transmission format. In a possible implementation, in response to a first or second risk score and/or classification that indicates the provider is at high risk for a medical malpractice claim or stop loss claim, an alert may be automatically generated and sent to the provider and/or the insurance company. The alert may include specific areas for the provider determined by the predictive model that are causing the predicted first or second risk score to be high. This allows the provider and/or the insurance company to proactively deploy resources to address emerging issues that put the provider at risk for a medical malpractice claim or stop loss claim.

In the embodiment of FIG. 6, a machine-learning based first predictive model is trained to predict risk of a medical malpractice claim and a second machine-learning based predictive model is trained to predict risk of a stop loss claim. In an alternative embodiment, a single machine-learning based predictive model can be trained as a multi-output model that computes a first risk score of a medical malpractice claim and a second risk score of a stop loss claim based on the same input provider data set. Accordingly, in this embodiment, the predictive model inputs the value-based care data and social factor data for the provider and computes the first and second risk scores (and/or classifications) based on that provider data. A combined premium for medical malpractice insurance and stop loss insurance can then be determined based on the first and second risk scores (and/or classifications). In another alternative embodiment, a single machine-learning based predictive model can be trained to compute a combined risk (and/or classification) for both medical malpractice and stop loss claims based on the value-based care and social factor data for a provider, and then the combined premium for medical malpractice insurance and stop loss insurance can be determined based on the combined risk score (and/or classification).

As described above, either two predictive models or a single predictive model outputs risk scores that can be used to price both medical malpractice insurance and stop loss. The scores are used to complement existing pricing methodologies to determine a collective premium for medical malpractice insurance and stop-loss insurance. As described herein, this method will provide a predictor of success in both value-based care programs and in reducing professional liability. Accordingly, providers with a favorable “risk score” stand to save considerable premium dollars for the following reasons. The findings determined via the processing the data through the predictive model(s) will predict success in two distinct areas of healthcare: (A) Reducing professional liability (the medical malpractice industry), and (B) Improving outcomes at a lower cost (the value-based/financial liability/stop-loss industry). These industries currently take two completely separate approaches to underwrite and price risks. The methodology, modeling, and even the data used to price policies is almost entirely different. However, using the predictive model(s) and methodology described herein, the two risks can actually be combined. Consider a patient who receives a $1,000,000 medical malpractice award after suing her orthopedist for negligence. Of that award, it is determined that $200,000 must be paid back to Medicare, because $200,000 is the amount that Medicare spent on the treatment needed as a result of the complications from the alleged negligence. Under a value-based care program, such as a bundled payment program, the orthopedist would be responsible for the $200,000 in complication costs (“financial risk”), not Medicare. So in this case, as long as the financial risk and liability risk are treated separately, that $200,000 is a redundant cost. Our inventive process will help eliminate that inefficiency. It will eliminate further inefficiency because that hypothetical $200,000 expense would be reduced (if not eliminated) by healthcare groups that are effectively running value-based care programs. Indeed, the complication might have been avoided altogether. But even if it wasn't, the ensuing costs are better contained under a well-managed value-based care program. Further, by addressing financial and professional risk collectively (one combined risk/premium instead of two), insurance company “expense ratios” will be greatly reduced, and that cost can also be passed on to the healthcare provider. The process and predictive model(s) for combined medical malpractice and stop loss insurance underwriting described herein will change the way healthcare (financial and professional) liability insurance is priced and delivered to healthcare providers who participate in value-based care programs. Without the process and predictive model(s) described herein, the professional liability industry will not have the tools, or understand how to use value-based care data, to identify or predict preventable complications. By extension, they will have no way to incorporate the efficiencies described herein.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer-implemented method comprising:
training a machine-learning based predictive model to predict a risk of a medical malpractice claim based on training cases with known outcomes and associated training provider data sets including value-based care data and social factor data;
retrieving a provider data set including value-based care data and social data for a provider;
inputting the provider data set into the trained machine-learning based predictive model;
predicting, using the trained machine-learning based predictive model, a risk score indicating a risk of a medical malpractice claim for the provider based on the input provider data set; and
determining a premium for medical malpractice insurance for the provider based on the risk score predicted using the trained machine-learning based predictive model.

2. The method of claim 1, wherein the value-based care data in the provider data set includes one or more of patient satisfaction scores, quality metrics, procedure outcome data, hospital readmission data, or utilization data.

3. The method of claim 1, wherein the social factor data in the provider data set includes one or more of social factor data associated with the provider or social factor data associated with patients of the provider.

4. The method of claim 3, wherein the social factor data associated with the provider includes one or more of credit score data, income data, spending data, data related to patient complaints, dated related to staff complaints, or data related to civil, criminal, or regulatory actions; and wherein the social factor data associated with the patients of the provider includes socio-economic data associated with the patients of the provider, including one or more of income, zip code, family circumstances data, or data regarding assets of the patients.

5. The method of claim 1, wherein training a machine-learning based predictive model to predict a risk of a medical malpractice claim based on training cases with known outcomes and associated training provider data sets including value-based care data and social factor data comprises:
identifying positive training cases in which providers were subject to medical malpractice claims and negative training cases in which providers were not subject to medical malpractice claims;
retrieving a training provider data set including value-based care data and social factor data for each of the positive training cases and for each of the negative training cases;
processing and cleaning the provider data sets for the positive and negative training cases to perform imputation of missing values, reduce excessive dimensionality, and address data imbalance; and
training the machine-learning based predictive model based on the training provider data sets and known outcomes of the positive training cases and negative training cases.

6. The method of claim 1, further comprising:
pre-processing the provider data set to perform imputation of missing values prior to inputting the provider data set into the trained machine-learning based predictive model.

7. The method of claim 1, wherein the machine-learning based predictive model is a deep neural network.

8. The method of claim 1, further comprising:
training a second machine-learning based predictive model to predict a risk of a stop loss claim based on training cases with known outcomes and associated training provider data sets including value-based care data and social factor data;
inputting a second provider data set, including value-based care data and social data for the provider, to the trained second machine-learning base predictive model; and
predicting, using the trained second machine-learning based predictive model, a second risk score indicating a risk of a stop loss insurance claim for the provider based on the input second provider data set;
wherein determining a premium for medical malpractice insurance for the provider based on the risk score predicted using the trained machine-learning based predictive model comprises:
determining a combined premium for medical malpractice insurance and stop loss insurance for the provider based on the risk score predicted using the trained machine-learning based predictive model and the second risk score predicted using the trained second machine-learning based predictive model.

9. A system comprising:
a processor; and
a memory storing computer program instructions, which when executed by the processor cause the processor to perform operations comprising:
training a machine-learning based predictive model to predict a risk of a medical malpractice claim based on training cases with known outcomes and associated training provider data sets including value-based care data and social factor data;
retrieving a provider data set including value-based care data and social data for a provider;
inputting the provider data set into the trained machine-learning based predictive model;
predicting, using the trained machine-learning based predictive model, a risk score indicating a risk of a medical malpractice claim for the provider based on the input provider data set; and
determining a premium for medical malpractice insurance for the provider based on the risk score predicted using the trained machine-learning based predictive model.

10. The system of claim 9, wherein the value-based care data in the provider data set includes one or more of patient satisfaction scores, quality metrics, procedure outcome data, hospital readmission data, or utilization data.

11. The system of claim 9, wherein the social factor data in the provider data set includes one or more of social factor data associated with the provider or social factor data associated with patients of the provider.

12. The system of claim 11, wherein the social factor data associated with the provider includes one or more of credit score data, income data, spending data, data related to patient complaints, dated related to staff complaints, or data related to civil, criminal, or regulatory actions; and wherein the social factor data associated with the patients of the provider includes socio-economic data associated with the patients of the provider, including one or more of income, zip code, family circumstances data, or data regarding assets of the patients.

13. The system of claim 9, wherein training a machine-learning based predictive model to predict a risk of a medical malpractice claim based on training cases with known outcomes and associated training provider data sets including value-based care data and social factor data comprises:
identifying positive training cases in which providers were subject to medical malpractice claims and negative training cases in which providers were not subject to medical malpractice claims;
retrieving a training provider data set including value-based care data and social factor data for each of the positive training cases and for each of the negative training cases; and
training the machine-learning based predictive model based on the training provider data sets and known outcomes of the positive training cases and negative training cases.

14. The system of claim 9, wherein the machine-learning based predictive model is a deep neural network.

15. A non-transitory computer-readable medium storing computer program instructions, which when executed by a processor cause the processor to perform operations comprising:
training a machine-learning based predictive model to predict a risk of a medical malpractice claim based on training cases with known outcomes and associated training provider data sets including value-based care data and social factor data;
retrieving a provider data set including value-based care data and social data for a provider;
inputting the provider data set into the trained machine-learning based predictive model;
predicting, using the trained machine-learning based predictive model, a risk score indicating a risk of a medical malpractice claim for the provider based on the input provider data set; and
determining a premium for medical malpractice insurance for the provider based on the risk score predicted using the trained machine-learning based predictive model.

16. The non-transitory computer-readable medium of claim 15, wherein the value-based care data in the provider data set includes one or more of patient satisfaction scores, quality metrics, procedure outcome data, hospital readmission data, or utilization data.

17. The non-transitory computer-readable medium of claim 15, wherein the social factor data in the provider data set includes one or more of social factor data associated with the provider or social factor data associated with patients of the provider.

18. The non-transitory computer-readable medium of claim 17, wherein the social factor data associated with the provider includes one or more of credit score data, income data, spending data, data related to patient complaints, dated related to staff complaints, or data related to civil, criminal, or regulatory actions; and wherein the social factor data associated with the patients of the provider includes socio-economic data associated with the patients of the provider, including one or more of income, zip code, family circumstances data, or data regarding assets of the patients.

19. The non-transitory computer-readable medium of claim 15, wherein training a machine-learning based predictive model to predict a risk of a medical malpractice claim based on training cases with known outcomes and associated training provider data sets including value-based care data and social factor data comprises:
identifying positive training cases in which providers were subject to medical malpractice claims and negative training cases in which providers were not subject to medical malpractice claims;
retrieving a training provider data set including value-based care data and social factor data for each of the positive training cases and for each of the negative training cases; and
training the machine-learning based predictive model based on the training provider data sets and known outcomes of the positive training cases and negative training cases.

20. The non-transitory computer-readable medium of claim 15, wherein the machine-learning based predictive model is a deep neural network.
